(19) United States
(12) Patent Application Publication
(10) Pub. No.: US 2013/0329933 A1
(43) Pub. Date: Dec. 12, 2013

(54) Hexagonal Headphone Earpiece

(71) Applicant: Timothy Val Kolton, Hollywood, CA (US)

(72) Inventor: Timothy Val Kolton, Hollywood, CA (US)

(21) Appl. No.: 13/489,721

(22) Filed: Jun. 6, 2012

(51) Int. Cl. H04R 1/10

(52) U.S. Cl. 381/371

(57) ABSTRACT

A hexagonal headphone earpiece includes a frame and overlaying pad, each of an elongated hexagonal shape, and oriented to have vertices of the hexagonal shape at a top end and a bottom end of the earpiece. The frame is resilient and supports the pad, which includes a foam cushion surrounded by an outer layer of material. Vents in the outer layer allow air to escape from the pad as it is compressed and decompressed, the vents preferably aimed away from a user's ear. A mesh spans the hexagonal shape, presenting a barrier between a user's ear and a headphone transducer.

### BACKGROUND

Headphones are known in the art as are headphone speaker cups and headphone earpieces for producing personalized sound reproduction. Headphone earpieces separate a speaker cup from a user's ear, promoting a secure, yet comfortable fit for the headphones.

U.S. Pat. No. 4,071,717 to Fidi et al. discloses a headphone earpiece for wearing on a person's ear, including a rigid plate between the speaker diaphragm and the pad, for distributing frictional resistance elements, and a plurality of openings adjacent the transducer. Although designed for improved sound characteristics, the round shape of the rigid plate is not designed for the natural shape of a wearer's ear.

U.S. Pat. No. 6,625,819 to Tsai discloses a headphone-type earpiece assembly and earpieces. The earpieces have a soft cloth covering supported with a flat frame and a clamping plate pivoted to the flat frame and disposed outside the soft cloth covering for securing the earpiece to a user's ear. Designs of this nature fail to secure the earpiece sufficiently for proper sound isolation, and result in poor sound reproduction. The design is also uncomfortable to many wearers as the mechanism for securing the earpiece is designed for ears of a single size and shape.

U.S. Pat. No. 7,172,052 to Lenhard-Backhaus discloses a headphone having earpieces pivotable about at least two pivot axes at a single point of intersection. Arms connect the earpieces to the headband. Although the pivoting arms of Lenhard-Backhaus allow the headphones to fit a variety of head shapes, they do not address the issue of proper fitting against a wearer's ear, which is crucial to proper sound reproduction.

There is therefore a need for an earpiece designed to provide comfort to the wearer while offering superior sound isolation characteristics. There is also a need for an earpiece having a shape compatible with a variety of ear sizes and shapes, and which engages portions of a user's ear for support, without constricting the entire ear.

### SUMMARY

An improved headphone earpiece includes a hexagonal frame attached to a hexagonal pad. The earpiece is positioned over a user's ear so that the top and bottom of the earpiece are corners or vertices of the hexagon. The hexagon has an irregular elongated shape making the distance between the top and bottom greater than the distance across the width of the earpiece (i.e., between the vertical sides of the hexagon). This shape has been demonstrated superior to other shapes (e.g., oval), because the combination of straight sections of the hexagon engage a user's ear more securely, while the elongated shape conforms to the overall shape of a user's ear.

The frame comprises a resilient flat member which may be deformable, made preferably of nylon, plastic, or a similar material, and is designed for a snap-fit into a speaker cup. The speaker cup has a corresponding shape, making the earpiece releasable and capable of being replaced or exchanged with another pad. A flexible mesh spans the frame helping to protect the transducer and other sensitive parts of the speaker cup. Ideally, the hexagonal frame is obscured from view by the hexagonal pad.

The pad is substantially the same shape and substantially overlays the hexagonal frame. In this manner, when a user wears headphones bearing the earpiece, a user's ears are covered and held in place by the hexagonal pad. The pad is resilient by virtue of an enclosed foam cushion for added comfort. Preferably the foam cushion is enclosed by an outer covering, which may be leather, faux leather, or a similar material comfortable to wear for extended periods of time.

To ensure a secure fit against a user's ear, and enhance external sound dampening, the outer covering includes a series of vents in its surface allowing air to rapidly exit and enter the foam cushion as it compresses and decompresses. Preferably, the vents are oriented away from a user's ear to avoid the detection of any accompanying sound. Additionally, the foam cushion may have a greater thickness at the top end and a lesser thickness at the bottom end of the hexagonal pad to promote a secure connection to a user's ear. In another embodiment, the bottom end is elongated more than the top end to promote a more secure fit.

### BRIEF DESCRIPTION OF THE FIGURES

FIG. 1 is a plan view of a hexagonal frame for a hexagonal earpiece.

FIG. 2 is a perspective view of a hexagonal earpiece.

FIG. 3 is a cut-away side view of a hexagonal earpiece.

### DESCRIPTION

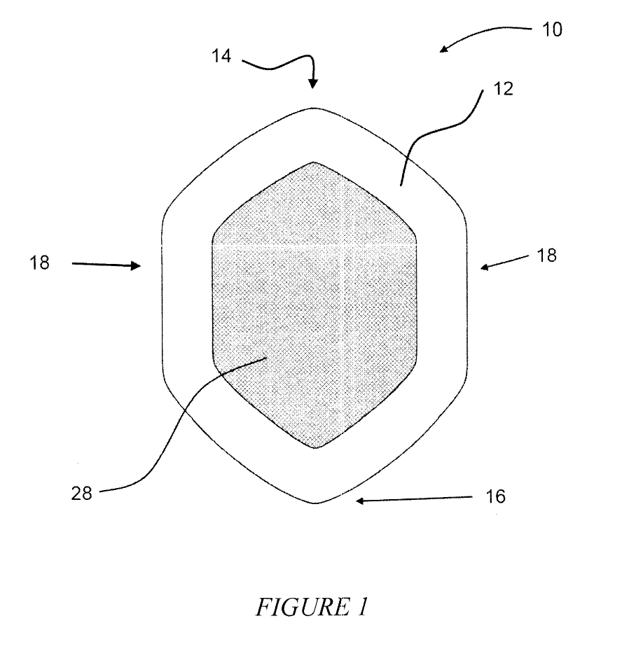

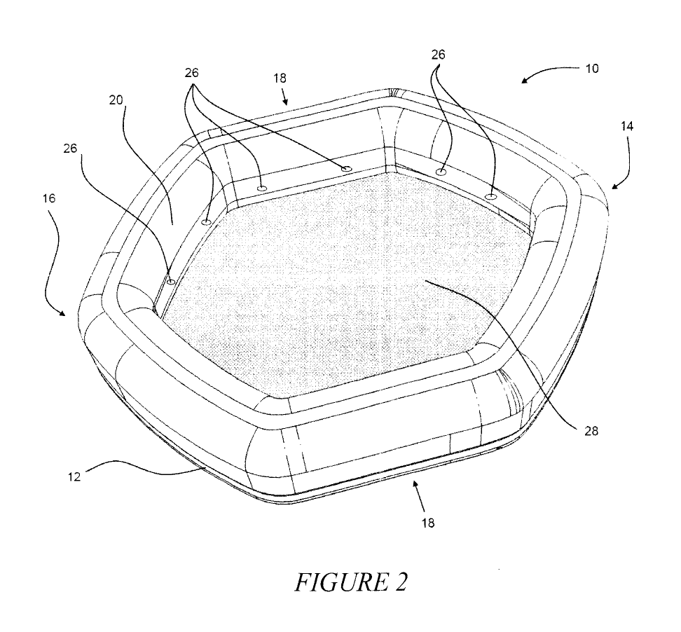

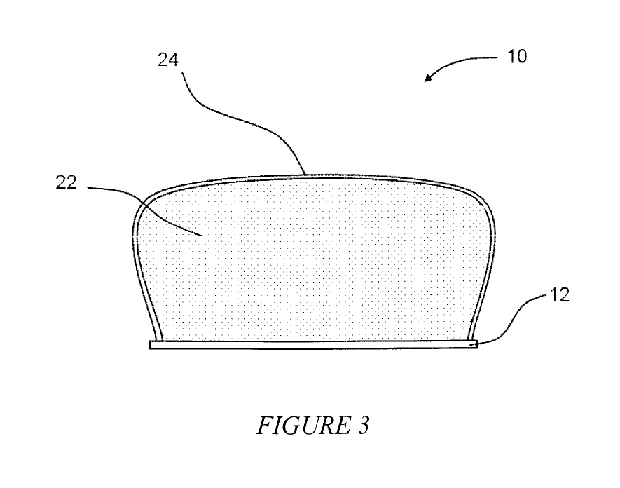

Referring to FIGS. 1-3, a headphone earpiece 10 is shown and described. The earpiece 10 comprises a hexagonal frame 12, and a hexagonal pad 20. The earpiece 10 is positioned relative to a user's ear such that a top end 14 and a bottom end 16 of the earpiece 10 comprise vertices of the hexagonal shape. The earpiece 10 is also characterized by an irregular elongated hexagonal shape such that the distance between the top end 14 and the bottom 16 end is greater than the distance between the vertical sides 18 of the hexagon.

The hexagonal frame 12 comprises a deformably resilient flat member designed for a releasable snap-fit into a headphone speaker cup (not shown) having a corresponding shape. A flexible screen or mesh 28 spans the inner dimensions of the hexagonal frame 12 and helps to protect the sound producing elements of the headphone speaker cup. In one preferred embodiment, the hexagonal frame 12 is obscured from view by the hexagonal pad.

The hexagonal pad 20 is of substantially the same shape and substantially overlays the hexagonal frame 12. In this manner, when headphones bearing the earpiece 10 are worn, a user's ear is covered and held in place by the hexagonal pad 20. The hexagonal pad 20 comprises an enclosed foam cushion 22 for added comfort when worn. Preferably the foam cushion 22 is enclosed by an outer covering 24. In various embodiments, the outer covering 24 may be made of leather, faux leather, or similar materials having a gentle and pleasing feel to the ear.

In order to ensure a secure fit against a user's ear and enhance external sound dampening, the outer covering 24 comprises a series of vents 26 along its surface to allow air to rapidly exit and enter the foam cushion 22 as the foam cushion 22 is compressed and decompressed. Preferably, the vents 26 are oriented on the hexagonal pad 20 away from a user's ear to avoid the detection of any sound accompanying compression and decompression of the hexagonal pad 20.

Preferably, the foam cushion 22 of the earpiece 10 has a greater thickness at the top end 14 of the hexagonal pad, and a lesser thickness at the bottom end 16 of the hexagonal pad to promote a secure connection to a user's ear. In another preferred embodiment the bottom end 16 of the hexagonal shape is elongated more than the top end 14, also to promote a more secure fit by the earpiece 10.

While particular forms of the headphone earpiece 10 have been illustrated and described, it will also be apparent to those skilled in the art that various modifications can be made without departing from the spirit and scope of the invention. Accordingly, it is not intended that the invention be limited except by the appended claims.

What is claimed is:

1. An earpiece for a headphone comprising:
a hexagonal frame oriented relative to the headphone with vertices at a top end and at a bottom end and two substantially vertical sides;
the hexagonal frame elongated such that the distance between the top end and the bottom end is greater than the distance between the vertical sides; and
a hexagonal pad substantially overlaying the hexagonal frame, such that when worn, a user's ear is covered and held in place by the hexagonal pad.

2. The earpiece of claim 1 wherein the hexagonal pad comprises an enclosed foam cushion.

3. The earpiece of claim 2 wherein the foam cushion is enclosed by an outer covering.

4. The earpiece of claim 3 wherein the outer covering comprises vents, allowing air to escape from the foam cushion as the hexagonal pad is compressed.

5. The earpiece of claim 4 wherein the vents face away from a user's ear.

6. The earpiece of claim 1 wherein the foam cushion has a greater thickness at the top end of the hexagonal pad, and a lesser thickness at the bottom end of the hexagonal pad.

7. The earpiece of claim 1 further comprising a mesh spanning the hexagonal frame.

8. The earpiece of claim 1 wherein the hexagonal frame is adapted to removably seat in the earpiece via a snap-fit.

9. The earpiece of claim 1 wherein the bottom end is elongated more than the top end.

10. An earpiece for a headphone comprising:
an irregular hexagonal frame oriented relative to the headphone with vertices at a top end and at a bottom end and two substantially vertical sides, adapted to removably seat in the earpiece via a snap fit.
the hexagonal frame elongated such that the distance between the top end and the bottom end is greater than the distance between the vertical sides;
the hexagonal pad comprising a foam cushion enclosed by an outer covering, the outer covering having vents facing away from a user's ear for allowing air to escape from the foam cushion;
the foam cushion having a greater thickness at the top end of the hexagonal pad, and a lesser thickness at the bottom end of the hexagonal pad;
a mesh spanning the hexagonal frame.
